(19) United States
(12) Patent Application Publication
(10) Pub. No.: US 2026/0318344 A1
(43) Pub. Date: Oct. 15, 2026

(54) Fastener for the Temporary Assembly of Structures

(71) Applicant: LISI AEROSPACE, Paris (FR)

(72) Inventor: Julien BRACHET, Mehun sur Yèvre (FR)

(73) Assignee: LISI AEROSPACE, Paris (FR)

(21) Appl. No.: 19/645,261

(22) Filed: Apr. 12, 2026

(30) Foreign Application Priority Data
Apr. 15, 2025 (FR) 2504000

(51) Int. Cl. F16B 19/10

(52) U.S. Cl. CPC F16B 19/109

(57) ABSTRACT

The invention relates to a fastener (10) for the temporary assembly of structures, comprising: a tubular hollow body (14); a tubular hooking element (16), comprising a clamp body (24), a set of spring clamps (26) and a threaded rod (28); a drive device (18), rotatable relative to the hollow body and adapted to cooperate with the threaded rod (28); and a spreader (20), positioned inside the hooking element (16). The threaded rod (28) of the hooking element is positioned inside the clamp body (24), with an annular space (30) left between the threaded rod and the clamp body. The drive device (18) is able to move axially within that annular space.

This invention involves a fastener for the temporary assembly of at least two pre-drilled structures comprising the following: a tubular hollow body, extending along a main axis; a tubular hooking element that can slide along the axis with respect to the hollow body; the hooking element comprises: a clamp body; several spring clamps connected to one end of the clamp body, each clamp comprising a hooking spur; a threaded rod; a drive device, rotatable relative to the hollow body and comprising a tapping adapted to cooperate with the threaded rod of the hooking element; a spreader, arranged inside the hooking element; the hollow body and the clamp body comprise, respectively, a first means and a second means for blocking rotation relative to each other around the main axis.

The invention relates specifically to temporary fasteners of the clamp type.

In the aeronautical industry, before performing the final assembly of two structural elements, it is common practice to carry out a temporary assembly of the elements using temporary fasteners inserted into the through-holes. Such temporary fasteners are described, in particular, in document EP4123187, in the name of LISI Aerospace.

A clamp fastener is used to join structures whose total thickness falls between a minimum and a maximum value; the gap between these values depends on the characteristics of the clamp fastener. In particular, the temporary fasteners described in EP4123187 enable structures to be assembled over a wide range of total thicknesses.

The aim of the invention is to improve existing fasteners by reducing their length.

To this end, the object of the invention is a fastener of the aforementioned type, in which the threaded rod of the hooking element is arranged inside the clamp body, with an annular space provided between the threaded rod and the clamp body, with the drive device able to move along an axis in the annular space.

Other advantageous aspects of the invention are that the fastener comprises one or more of the following features, taken individually or according to all technically possible combinations:
either the hollow body or the clamp body comprises: a substantially cylindrical outer surface; and at least two grooves formed longitudinally in the outer surface; the other of the hollow body and the clamp body comprises at least two longitudinal tabs; and the fastener is configured so that each tab is able to slide axially in one of the grooves;
the hollow body comprises the outer surface and at least two grooves; and the clamp body comprises at least two longitudinal tabs;
the threaded rod extends between a first and a second end, directed respectively towards the set of spring clamps and towards the drive device, the first end of the threaded rod being fixed to the end of the clamp body connected to the spring clamps;
the threaded rod is tubular and defines an internal space extending along the main axis, with the spreader mobile along an axis in the internal space;
the threaded rod comprises at least one longitudinal slot, opening into the internal space; and the fastener also comprises a third means for blocking rotation, integral with the hollow body and able to slide along an axis in at least one longitudinal slot;
the hollow body comprises a front opening directed toward the set of spring clamps, with the front opening including a first anti-rotation form; and the threaded rod includes a second anti-rotation form that cooperates with the first to guide axial movement of the threaded rod within the front opening of the hollow body;
the first anti-rotation form comprises at least one internal flat spot included in an edge of the front opening of the hollow body; and the second anti-rotation form comprises at least one external flat spot provided on the threaded rod;
the spreader is fixed relative to the hollow body;
the spreader is fixed relative to the drive device;
the hollow body features an enlarged head designed to bear against a first face of the structures.

The invention also relates to an assembly comprising the following: structures to be assembled, comprising first and second opposing faces, and a hole opening to each of the first and second faces; and a fastener as described above, set in the hole, with the hooking spurs of the clamps positioned around the spreader, with the head of the hollow body and the hooking spurs coming into contact with the first face and the second face of the structures respectively.

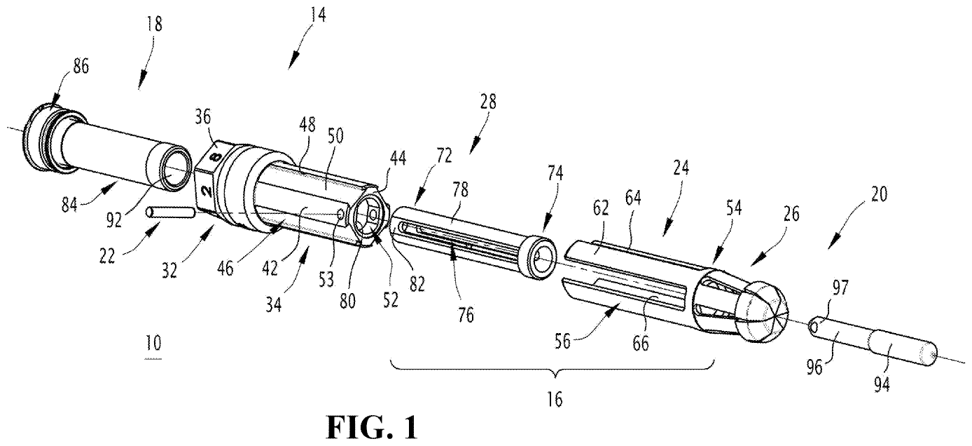

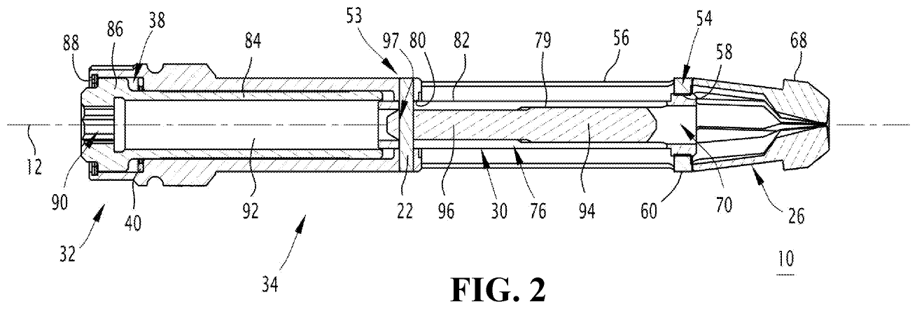

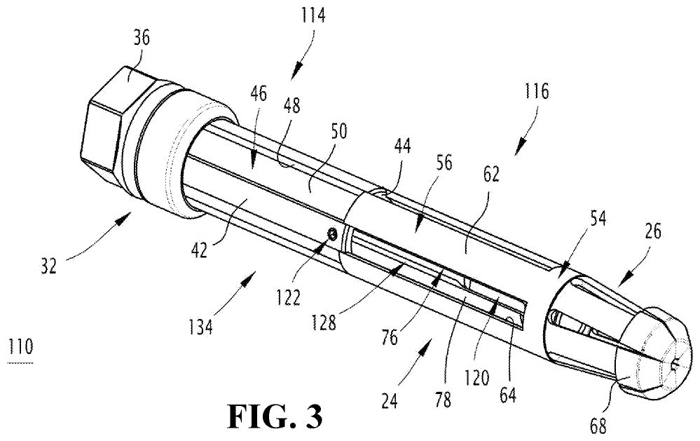

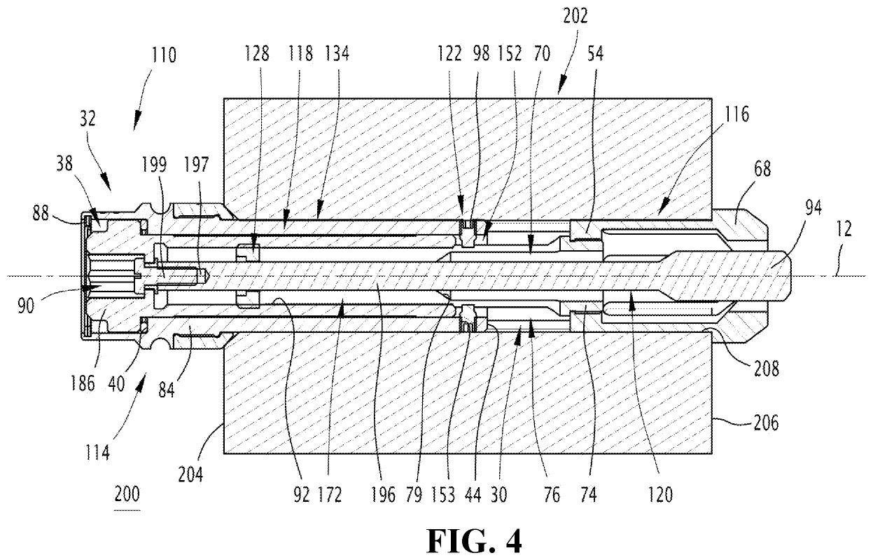

The invention will become clearer upon reading the following description, which is provided solely as a non-limiting example, and with reference to the drawings, in which:
FIG. 1 is an exploded view of a fastener according to a first embodiment of the invention, in a first configuration;
FIG. 2 is a cross-section view of the fastener in FIG. 1, in the first configuration;
FIG. 3 is a perspective view of a fastener according to a second embodiment of the invention, in a first configuration; and
FIG. 4 is a cross-section view of an assembly comprising the fastener of FIG. 3 in a second configuration.

FIGS. 1 to 2 represent a fastener 10 according to a first embodiment of the invention. FIGS. 3 and 4 represent a fastener 110 according to a second embodiment of the invention. More specifically, FIG. 4 shows an assembly 200 comprising the fastener 110.

Each of the fasteners 10 and 110 is suitable for temporarily joining at least two previously drilled structures 202, to form assembly 200 (FIG. 4) or a similar assembly, as described in the aforementioned document EP4123187.

Fasteners 10 and 110 will be described simultaneously hereinafter, the common elements being designated by the same reference numbers.

Fastener 10, 110 extends along a main axis 12 and comprises: a hollow body 14, 114; a hooking element 16, 116; a drive device 18, 118; a spreader 20, 120; and a sliding component 22, 122.

The hollow body 14, 114 is tubular in shape, and extends along the main axis 12 between two open ends. The hollow body 14, 114 will be described in more detail below.

The hooking element 16, 116 comprises: a clamp body 24; a set of spring clamps 26; and a threaded rod 28, 128. The spring clamps will be described later.

The clamp body 24 extends along the main axis 12 between two ends. As will be explained below, the clamp body 24 is substantially tubular in shape, with both ends open.

In addition, as will be explained below, the threaded rod 28, 128 of the hooking element 16, 116 is arranged inside the clamp body 24, with an annular space 30 being provided between the threaded rod and the clamp body.

Furthermore, as will be explained below, the hollow body 14, 114 and the hooking element 16, 116 are rotationally blocked (or “rotationally locked”) relative to each other, i.e., cannot rotate relative to each other around the main axis 12, and can slide along the main axis.

The hollow body 14, 114 of the embodiments shown will be described in greater detail.

The hollow body 14, 114 comprises an enlarged head 32 and a tubular shaft 34, 134. In the remainder of the description, the head 32 of the hollow body 14, 114 is considered to represent a rear end of the hollow body and of the fastener 10, 110, the terms “front” and “rear” being understood according to this definition.

The head 32 includes first mounting surfaces 36 capable of being fitted to an installation tool (not shown) of the fastener 10, 110, to prevent rotation of the head 32. In the embodiment shown, the first mounting surfaces 36 are hexagonal.

The head 32 also features an open rear cavity 38, bounded axially by a shoulder 40.

The tubular shaft 34, 134 comprises a first means for blocking rotation of the hollow body 14, 114 and the hooking element 16, 116 relative to each other. More precisely, the tubular shaft 34, 134 comprises: an outer surface 42, substantially circular-cylindrical around the main axis 12; a front face 44, substantially flat and perpendicular to the main axis 12; and at least two grooves 46, formed longitudinally in the outer surface 42 and opening onto the front face 44. These grooves 46 form the first means of blocking rotation.

Each groove 46 comprises two first longitudinal edges 48 and a bottom 50, arranged between the first longitudinal edges. The first longitudinal edges 48 and the bottom 50 are preferably substantially flat and parallel to the main axis 12.

The grooves 46 are preferably similar in shape and are evenly spaced at an angle around the main axis 12. In the embodiments shown, the tubular shaft 34, 134 comprises four grooves 46.

The tubular shaft 34, 134 also includes a front opening 52, 152, in the front face 44. The front opening 52, 152 will be described later.

The tubular shaft 34, 134 also comprises two holes 53, 153, transversely crossing the outer surface 42 of the shaft 34, 134 and substantially symmetrical to each other with respect to the main axis 12. The holes 53, 153 are axially close to the front face 44 of the shaft 34, 134 and spaced at angles away from the grooves 46.

The hooking element 16, 116 of the embodiments shown will be described in greater detail.

The clamp body 24 of the hooking element 16, 116 comprises a second means for blocking rotation of the hollow body 14, 114 and the hooking element 16, 116 relative to each other, capable of cooperating with the first means for blocking rotation carried by the tubular shaft 34, 134.

More specifically, the clamp body 24 comprises a ring 54 and at least two tabs 56.

The ring 54 is arranged around the main axis 12 and forms a front end of the clamp body 24. The ring 54 comprises inner surface 58 and outer surface 60 that are substantially circular-cylindrical.

Preferably, the inner surface 58 of the ring 54 comprises a means of attachment to the threaded rod 28, 128, as will be described below.

Tabs 56 form the second rotation-blocking device described above. More specifically, each of the tabs 56 extends rearwards from the ring 54, parallel to the main axis 12. The outer surface 62 of each tab continues the substantially cylindrical outer surface 60 of the ring.

Tabs 56 are spaced at angles to one another. Each tab 56 has two second longitudinal edges 64 and an inner surface 66, arranged between the second longitudinal edges. The second longitudinal edges 64 and the inner surface 66 are preferably substantially flat and parallel to the main axis 12.

The tabs 56 are preferably similar in shape and are evenly spaced at an angle around the main axis 12.

Each tab 56 of the clamp body 24 is able to slide along an axis in a groove 46 of the shaft 34, 134 of the hollow body 14, 114, during axial sliding of the hollow body 14, 114 and the hooking element 16, 116 relative to each other. Preferably, the number of tabs 54 is equal to the number of grooves 46 of the shaft 34, 134.

More precisely, the second longitudinal edges 64 and the inner surface 66 of each tab 56 are able to slide along an axis against the first longitudinal edges 48 and the bottom 50 of one of the grooves 46. The hollow body 14, 114 and the hooking element 16, 116 are thus rotationally blocked and axially translatable relative to each other.

Preferably, the outer surface 62 of each of the tabs 56 forms a continuous cylinder with the outer surface 42 of the tubular shaft 34, 134 of the hollow body 14, 114.

In a first configuration of the fastener 10, 110, shown in FIGS. 1 to 3, a rear end of each tab 56 is positioned close to a front end of the corresponding groove 46. In a second configuration of the fastener 10, 110, visible in FIG. 4 for fastener 110, the rear end of each tab 56 is positioned close to a rear end of the corresponding groove 46.

Each of the spring clamps 26 of the hooking element 16, 116 extends axially between a front end and a rear end. The rear end of each spring clamp 26 is attached to the ring 54 of the clamp body 24. The front end of each spring clamp 26 features a hooking spur 68, projecting radially away from the main axis 12.

The spring clamps 26 are substantially identical and evenly distributed around the main axis 12. In the embodiments shown, there are six spring clamps 26.

The spring clamps 26 are deformable between a retracted and an extended conformation. In the retracted configuration shown in FIGS. 1 to 3, hooking spurs 68 of adjacent clamps are in contact. In the deployed configuration shown in FIG. 4, the hooking spurs 68 are spaced laterally from one another. The retracted conformation corresponds to a configuration of the spring clamps 26 at rest, without external constraint.

As will be explained below, in the first and second configurations of fastener 10, 110, the spring clips 26 are respectively in the retracted and extended conformation.

The threaded rod 28, 128 of the hooking element 16, 116 is tubular in shape and defines an internal space 70, open at both ends of the threaded rod 28, 128.

More precisely, the threaded rod 28, 128 comprises a main portion 72, 172 and a front portion 74. The annular space 30 is radially bound by the outer surface of the main portion 72, 172 of the threaded rod 28, 128, on the one hand, and by the inner surfaces 66 of the tabs 56 of the clamp body 24, on the other.

The main portion 72, 172 comprises at least one longitudinal slot 76, opening onto the internal space 70. At least one longitudinal slot 76 extends parallel to the main axis 12, between a closed front end and a closed rear end.

Preferably, as in the embodiments shown, the main portion 72, 172 comprises two longitudinal slots 76, symmetrical to each other with respect to the main axis 12.

The main portion 72, 172 further comprises a first external thread 78, traversed by at least one longitudinal slot 76.

In the embodiments shown, the main portion 72, 172 of the threaded rod 28, 128 also comprises a forward-facing internal shoulder 79, partially delimiting the internal space 70.

The front portion 74 of the threaded rod 28, 128 is integral with the clamp body 24, so as to form the hooking element 16, 116. Preferably, the front portion 74 is fixed to the inner surface 58 of the ring. In one embodiment, the front portion 74 of the threaded rod 28, 128 comprises a second external thread, and the inner surface 58 of ring 54 has threads (also referred to herein as a “tapping”) that cooperates with the outer thread.

The main portion 72, 172 of the threaded rod 28, 128 is able to slide along an axis in the front opening 52, 152 of the tubular shaft 34, 134 during axial sliding of the hollow body 14, 114 and the hooking element 16, 116 relative to each other, as described above.

The drive device 18, 118 of the illustrated embodiments will be described in more detail.

The drive device 18, 118, also referred to in the description as a “pulling rod”, extends along the main axis 12 and is designed to rotate within the hollow body 14, 114.

In the embodiments shown, the pulling rod 18, 118 has a main portion 84 and an enlarged rear portion 86, 186. The rear portion 86, 186 is positioned in the rear cavity 38 of the enlarged head 32 of the hollow body 14, 114.

In an embodiment not shown, the pulling rod 18, 118 is locked in axial translation relative to the hollow body 14, 114. In the embodiments shown, the rear portion 86, 186 of the pulling rod 18, 118 has a short axial travel in the rear cavity 38 of the head 32, between the shoulder 40 and a snap ring 88 which locks the rear portion 86, 186 in the rear cavity 38. In the first and second configurations of fastener 10, 110, the rear portion 86, 186 of pulling rod 18, 118 is located at first and second axial distances from shoulder 40 of rear cavity 38, respectively, the second axial distance being less than the first.

A rear end of the pulling rod 18, 118 has second mounting surfaces, intended to cooperate with the aforementioned installation tool, to rotate the pulling rod 18, 118 relative to the hollow body 14, 114. In the embodiments shown, the second mounting surfaces are formed by axial indentation 90.

The pulling rod 18, 118 forms a helical link with the hooking element 16, 116, the rotation of the pulling rod thus enables the hooking element to slide along an axis in relation to the body 14, 114. In the embodiment shown, the pulling rod 18, 118 is tubular with two open ends, and features a tapping 92 on the inner surface of the main portion 84. The tapping 92 is capable of cooperating with the first external thread 78 of the main portion 72, 172 of the threaded rod 28, 128.

The spreader 20, 120 of the embodiments shown will be described in greater detail.

The spreader 20, 120 has a front part 94 and a rear part 96, 196, adjacent to each other along the main axis 12. Each of the front parts 94 and the rear parts 96 and 196 has a cylindrical shape, preferably a circular cylinder. Preferably, the diameter of front part 94 is larger than that of rear parts 96 and 196.

The rear part 96, 196 of the spreader 20, 120 has a bore 97, 197 which will be described later.

The spreader 20, 120 is arranged in the internal space 70 of the threaded rod 28, 128 and axially movable relative to the threaded rod 28, 128, as described more precisely below.

In the first configuration of the fastener 10, 110, shown in FIGS. 1 to 3, the front part 94 of the spreader 20, 120 is in rear abutment with the internal shoulder 79 of the main portion 72, 172 of the threaded rod 28, 128. Furthermore, in the first configuration of the fastener 10, 110, the front part 94 of the spreader 20, 120 is axially located behind the hooking spurs 68 of the spring clamps 26. The the spring clamps 26 are then in the retracted conformation described above.

In the second configuration of the fastener 10, 110, shown in FIG. 4, the hooking spurs 68 of the spring clamps 26 are axially aligned with and arranged around the front part 94 of the spreader 20, 120. The spring clamps 26 are then in the deployed configuration described above.

As will be described in more detail below, the sliding component 22, 122 of the fastener 10, 110 is fixed to the hollow body 14, 114 and has at least one radial projection suitable for passing through the at least one longitudinal slot 76 of the main portion 72, 172 of the threaded rod 28, 128. The sliding component 22, 122 thus forms a means for blocking rotation of the hooking element 16, 116 with respect to the hollow body 14, 114.

When the fastener 10, 110 changes from the first to the second configuration and vice versa, the threaded rod 28, 128 is thus able to slide along an axis inside the hollow body 14, 114 and around the spreader 20, 120, simultaneously with the sliding of the tabs 56 of the clamp body 24 in the grooves 46 of the shaft 34, 134 of the hollow body 14, 114.

In the first configuration of fastener 10, 110, the sliding component 22, 122 is arranged at the rear end of at least one longitudinal slot 76. In the second configuration of the fastener 10, 110, the sliding component 22, 122 is close to or in contact with the front end of at least one longitudinal slot 76.

Fastener 10 of FIGS. 1 and 2 will now be described in more detail.

In the embodiment shown in FIGS. 1 and 2, the spreader 20 is fixed relative to the hollow body 14. More precisely, in the embodiment shown in FIGS. 1 and 2, the perforation 97 in the rear part 96 of the spreader 20 is arranged transversely to the main axis 12; and the sliding component 22 is a pin which passes through both the holes 53 in the tubular shaft 34, close to the front face 44, and the the bore 97 in the rear part 96 of the spreader 20. The pin 22 thus holds the spreader 20 stationary relative to the hollow body 14.

In addition, the pin 22 passes through the longitudinal slots 76 of the main portion 72 of the threaded rod 28, forming a means for rotationally locking the hooking element 16 with respect to the hollow body 14 and, accordingly, blocking rotation of the hooking element 16 relative to the hollow body 14.

In the embodiment shown in FIGS. 1 and 2, the fastener 10 includes an additional means for rotationally blocking the hooking element 16 relative to the hollow body 14. More precisely, the front opening 52 of the tubular shaft 34 comprises a first anti-rotation form 80; and the main portion 72 of the threaded rod 28 comprises a second anti-rotation form 82, able to cooperate with the first anti-rotation form 80 to block rotation of the hooking element 16 with respect to the hollow body 14. Such cooperation also improves the alignment of the hooking element 16 with the main axis 12, to facilitate axial sliding of the rod in the front opening 52 of the hollow body.

In particular, in the embodiment shown in FIGS. 1 and 2, the first anti-rotation form comprises at least one internal flat spot 80, formed at the front end of the tubular shaft 34 and partially forming an edge of the front opening 52; and the second anti-rotation form comprises at least one external flat spot 82 formed longitudinally on the main portion 72, 172 of the threaded rod 28, 128. Each of the inner 80 and outer 82 flat spots is flat and parallel to the main axis 12.

Preferably, the first anti-rotation form comprises two inner flat spots 80 symmetrical to each other with respect to the main axis 12; and the second anti-rotation form comprises two outer flat spots 82 symmetrical to each other with respect to the main axis 12. In the embodiment shown in FIGS. 1 and 2, the pin 22 passes through the inner flat spots 80 of the tubular shaft 34, and each longitudinal slot 76 of the main portions 72 and 172 of the threaded rod 28 and 128 is formed at an outer flat spot 82.

The 110 fastener shown in FIGS. 3 and 4 will now be described in more detail.

In the embodiment shown in FIGS. 3 and 4, the spreader 120 is fixed relative to the pulling rod 118. More precisely, in the embodiment shown in FIGS. 3 and 4, the bore 197 in the rear portion 196 of the spreader 120 is made axially and oriented toward the rear, and the fastener 110 further includes a screw 199 arranged in the bore 197, which fastens the spreader 120 to the rear portion 186 of the pulling rod 118. The main portion 84 of the pulling rod 118 is arranged around the rear part 196 of the spreader 120.

Furthermore, in the embodiment shown in FIGS. 3 and 4, the sliding component 122 is formed by two slugs 98, aligned perpendicular to the main axis 12. Each slug 98 is arranged in one of the holes 153 of the tubular shaft 134 of the hollow body 114 and forms an internal projection with respect to the tubular shaft, close to the front face 44. The slugs 98 are arranged on either side of the rear part 196 of the spreader 120.

In addition, each slug 98 is arranged in one of the longitudinal slots 76 of the main portion 172 of the threaded rod 128, forming a means for blocking rotation of the hooking element 116 with respect to the hollow body 114.

In addition, the slugs 98 axially hold the threaded rod 128 in the hollow body 114 to ensure that the tapping 92 of the pulling rod 118 always engages with the first external thread 78 of the threaded rod. Without the slugs 98, forward movement of the pulling rod 118 would push the threaded rod 128 forward, making it impossible for the pulling rod and threaded rod threads to engage.

In one embodiment, the holes 153 in the tubular shaft 134 are threaded; and the slugs 98 are in the form of screws with a drive recess.

Furthermore, in the embodiment shown in FIGS. 3 and 4, the front opening 152 of the tubular shaft 134 is circular in shape and does not include an anti-rotation form. The rotational locking of the hooking element 116 relative to the hollow body 114, thereby blocking relative rotation, is achieved solely by the assembly of grooves 46 and tabs 56 and by the interaction between the sliding component 122 and the hooking element 116, as described above.

Similarly, in the embodiment shown in FIGS. 3 and 4, the main portion 172 of the threaded rod 128 has a substantially circular cross-section and no flattened portion.

According to a variant not shown, the fastener 110 described above comprises the first and second anti-rotation features 80, 82 described above for fastener 10.

A method for installing the fastener 10, 110 into the structures 202 will now be described.

The structures 202, shown as a single block in FIG. 4, define two opposing faces, 204 and 206. A hole 208 passes through structures 202 from the first face 204 to the second face 206.

At the beginning of the installation process, the fastener 10, 110 corresponds to the first configuration shown in FIGS. 1 to 3.

The fastener 10, 110 is inserted into the hole 208 of the structures 202, so that the enlarged head 32 of the hollow body 14, 114 abuts the first face 204 and the spring clamps 26 protrude beyond the second face 206.

An axial force is then applied to the enlarged head 32, pressing it against the first face of the structures, while being locked in rotation by action on the first mounting surfaces 36.

At the same time, the pulling rod 18, 118 is rotated relative to the head 32, by applying a torque to the pulling rod through the axial recess 90.

The tapping 92 of the pulling rod then engages the first external thread 78 on the threaded rod 28, 128. The threaded rod 28, 128 thus moves toward the enlarged head 32 of the hollow body 14, 114, thereby causing movement of the entire hooking element 16, 116. More precisely, the tabs 56 of the clamp body 24 are slid back into the grooves 46 of the shaft 34, 134 of the hollow body 14, 114.

The rotational locking of the hooking element 16, 116 relative to the hollow body 14, 114, thereby blocking relative rotation, is preferably achieved by two torque reaction mechanisms: on one hand, the first and second longitudinal edges 48 and 64 of the grooves 46 and tabs 56; on the other hand, the sliding component 22, 122 within the longitudinal slots 76 of the main portion 72, 172 of the threaded rod 28, 128.

During axial displacement of the hooking element 16, 116 relative to the hollow body 14, 114, the main portion 84 of the pulling rod 18, 118 moves axially in the annular space 30 formed between the threaded rod 28, 128 and the clamp body 24.

Due to the displacement of the hooking element 16, 116 relative to the body 14, 114, the hooking spurs 68 of the clamps 26 arrive axially opposite the end 94 of the spreader 20, 120. The spring clamps 26 thus deform to the deployed conformation described above, so that the hooking spurs 68 form a circle with a diameter greater than the diameter of the hole in the structures. The hooking spurs 68 then project radially from the hole.

As the rotation drive of pulling rod 18, 118 continues, the hooking spurs 68 come to rest axially against the second face of the structures, around the hole.

If the rotation drive of pulling rod 18, 118 then continues, the rear portion 86, 186 of the pulling rod moves axially forward in the rear cavity 38 of the head 32, towards the shoulder 40. A compressive force is thus applied to the fastener 10, 110, so as to clamp the structures to be joined together.

In the fastener 10, 110 described above, the arrangement of the threaded rod 28, 128 inside the clamp body 24 allows the threaded rod to have an axial length similar to that of the tabs 56, without increasing the overall length of the hooking element 16, 116.

This hooking element 16, 116, which is also sliding and the same diameter as that of the hollow body 14, 114, thus provides a large clamping range between the thicknesses of the structures to be joined, while maintaining a short fastener length in the first configuration.

1. A fastener, for the temporary assembly of at least two previously perforated structures, said fastener comprising:
a tubular hollow body extending along a main axis;
a tubular hooking element (16, 116), capable of sliding axially with respect to the hollow body, including a clamp body, a plurality of spring clamps connected to one end of said clamp body, each spring clamp comprising a hooking spur and a threaded rod;
a drive device, rotatable relative to the hollow body, including a tapping configured to cooperate with the threaded rod of the hooking element; and
a spreader positioned inside the hooking element;
wherein
the hollow body and the clamp body are respectively configured such that rotation relative to one another about the main axis is prevented;
the threaded rod of the hooking element is arranged inside the clamp body;
an annular space is located between said threaded rod and the clamp body; and
the drive device is able to move axially in said annular space.

2. A fastener according to claim 1, wherein
one of the hollow body and the clamp body comprises a substantially cylindrical outer surface and at least two grooves formed longitudinally in said outer surface; and
the other of the hollow body and the clamp body comprises at least two longitudinal tabs and the fastener is configured so that each tab can slide axially in one of the grooves.

3. A fastener according to claim 2, wherein
the hollow body comprises an outer surface and at least two grooves; and
the clamp body comprises at least two longitudinal tabs.

4. A fastener according to claim 1, wherein
the threaded rod extends between a first end and a second end, directed respectively towards the set of spring clamps and towards the drive device; and
the first end of said threaded rod is secured to the end of the clamp body connected to the spring clamps.

5. A fastener according to claim 1, wherein
the threaded rod is tubular in shape and defines an internal space extending along the main axis; and
the spreader is axially movable in said internal space.

6. A fastener according to claim 5, wherein
the threaded rod comprises at least one longitudinal slot opening onto the internal space and means for preventing rotation, integral with the hollow body and able to slide axially in at least one longitudinal slot.

7. A fastener according to claim 3, wherein
the hollow body comprises a front opening directed towards the set of spring clamps an including a first anti-rotation form; and
the threaded rod comprises a second anti-rotation form configured to cooperate with the first anti-rotation form to guide axial sliding of said threaded rod in the front opening of the hollow body.

8. A fastener according to claim 7, wherein
the threaded rod is tubular in shape and defines an internal space extending along the main axis;
the spreader is axially movable in said internal space;
the threaded rod comprises at least one longitudinal slot opening onto the internal space and means for preventing rotation integral with the hollow body and able to slide axially in at least one longitudinal slot;
the first anti-rotation form comprises at least one internal flat spot formed in an edge of the front opening of the hollow body; and
the second anti-rotation form comprises at least one external flat spot arranged on the threaded rod.

9. A fastener according to claim 1, wherein
the spreader is fixed relative to the hollow body.

10. A fastener according to claim 1, wherein
the spreader is fixed relative to the drive device.

11. A fastener according to claim 1, wherein
the hollow body includes means for preventing rotation of the hollow body relative to the clamp body about the main axis; and
the clamp body includes means for preventing rotation of the clamp body relative to the hollow body about the main axis.

12. A fastener according to claim 1, wherein
the hollow body comprises an enlarged head designed to bear against a first face of the structures.

13. An assembly, comprising:
structures to be assembled, including first and second opposing faces and a hole opening to each of said first and second opposing faces; and
the fastener claimed in claim 12 with the spring clamps being positioned in the hole, the hooking spurs of said spring clamps positioned around the spreader and the head and the hooking spurs in contact with the first face and the second face of the structures, respectively.
